(19) United States
(12) Patent Application Publication
(10) Pub. No.: US 2008/0196430 A1
(43) Pub. Date: Aug. 21, 2008

(54) VARIABLE RESTRICTOR

(76) Inventors: IAN CAMPBELL McGILL, AUCKLAND (NZ); LING JIANG WANG, AUCKLAND (NZ); WEI GAO, AUCKLAND (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/954,034

(22) Filed: Dec. 11, 2007

Related U.S. Application Data
(60) Provisional application No. 60/869,424, filed on Dec. 11, 2006.

(51) Int. Cl. F25B 41/06; F25B 49/00; F16K 31/02; G05D 7/06

(52) U.S. Cl. 62/228.1; 62/511; 251/319; 138/45; 251/129.06

(57) ABSTRACT

A variable restrictor including a tube with first and second ends of a first cross-sectional area and a region between the ends of reduced cross-sectional area. The region comprises a flattened portion of the tube where the tube has been permanently deformed such that opposed wall portions of the tube are much closed together than in the remainder of the tube. An actuator is arranged to selectively alter the separation of the opposed wall portions of the flattened section.

### BACKGROUND TO THE INVENTION

1. Field of the Invention

The present invention relates to a variable restrictor, most particularly to a variable restrictor for incorporation as an expansion device in a vapour compression refrigeration system. The present invention also relates to refrigeration systems incorporating such a valve.

2. Summary of the Prior Art

Vapour compression refrigeration systems typically used in domestic refrigeration appliances include a compressor, a condenser, an expansion device and an evaporator. The compressor receives gaseous refrigerant at low pressure and temperature and expels gaseous refrigerant at high pressure and high temperature. The high temperature high pressure gas enters the condenser, where heat is extracted and the refrigerant condenses to a liquid phase. An expansion device separates this high pressure side of the refrigeration system from a low pressure side. High pressure liquid refrigerant leaves the condenser. Low pressure liquid or mixed phase refrigerant exits the expansion device to the evaporator. Refrigerant changing phase from liquid to gas absorbs energy in the evaporator.

Refrigeration systems of this type for use in domestic refrigeration appliances have usually operated on a duty cycle. The refrigeration compressor runs for a period of time at its working capacity and is subsequently cycled off for a period of time before running again. The proportion of time spent operating and the timing of on and off cycling of the compressor typically depends on the temperature of one or more compartments of the refrigerator and the ambient air. In these systems the mass flow rate capacity of the compressor during operation is a known parameter and is essentially fixed. Accordingly it has been possible to choose an expansion device of fixed characteristic such as a plate with orifice of fixed size (in large scale systems) or, more typically in small systems, a long length of small diameter tube usually referred to as a capillary tube.

More recently variable capacity compressors have been proposed for use in domestic refrigerator appliances. It has been proposed to incorporate compressors variable flow capacity in the refrigeration systems of domestic refrigeration appliances. These compressors may operate on the basis of varying speed or varying pump stroke. The potential of these systems is to eliminate inefficiencies associated with transitions between operating and non-operating conditions of the refrigeration cycle, and to reduce temperature differences across the evaporator and the condenser in the refrigeration compartments. However in these systems, for refrigeration efficiency, the pressure drop across the expansion device should be substantially constant across the operating range of the compressor. With an expansion device of fixed characteristic, such as a fixed size orifice or capillary tube, the pressure drop will be insufficient for good efficiency at lower refrigerant flow rates and too high at higher refrigerant flow rates.

### SUMMARY OF THE INVENTION

It is an object of the present invention to provide a variable flow valve which will at least provide the industry with a useful choice, or to provide a refrigeration appliance incorporating a variable flow valve, which will at least provide the public with a useful choice.

In a first aspect the invention may broadly be said to consist in a variable restrictor comprising:
a tube having first and second ends of a first cross-sectional area and a region between said ends of reduced cross-sectional area, said region comprising a flattened portion of said tube where said tube has been permanently deformed such that opposed wall portions of said tube are much closer together than in the remainder of said tube, and an actuator arranged to selectively alter the separation of said opposed wall portions of said flattened section.

Preferably said tube is of a metal.

Preferably said flattened section when uncompressed; has a flow resistance between 1.5 m of 0.91 mm inside diameter capillary tube and 5.0 m of 0.66 mm inside diameter capillary tube.

Preferably the minimum cross-sectional opening area of said flattened section when in its most restricted state, is less than 50×10⁻⁹ m².

Preferably said opposed walls without forced displacement by said actuator are less than 100 micrometers apart.

Preferably said actuator is operable to pinch said flattened portion by pressing together on the outer surfaces of said opposed walls.

Preferably said actuator has an unactivated condition, and in said unactivated condition said actuator partially compresses said flattened section.

Preferably said actuator is actuable in a first manner from said unactivated condition to allow expansion of said flattened section.

Preferably said actuator is actuable in a second manner from said unactivated condition to further compress said flattened section.

Preferably said actuator includes:
a clamp including opposed surfaces, said flattened section passing between said opposed surfaces,
a flexible substrate connecting, between elements of said clamp such that deflection forces of said substrate are transmitted to said opposed surfaces, piezoelectric drive means fixed to said flexible substrate such that applying voltage to said piezoelectric drive means causes deflection forces in said substrate.

Preferably said piezoelectric drive means comprises multiple thin piezo elements distributed on a substantially planar surface of said substrate.

Preferably said flexible substrate comprises a thin disc and said piezo electric drive means is distributed over said disc.

Preferably the perimeter of said disc is supported by a support rings said support ring having a substantially rigid relation with a first said opposed surface of said clamp, and a portion of said disc spaced from said support ring contacting a drive portion of said clamp that is substantially rigidly connected to the other said opposed surface but movable relative to said first opposed surface.

Preferably said restrictor include pressure support surfaces supporting the wall of said tube in the region adjacent said opposed clamp surfaces.

Preferably said drive portion of said clamp is flexibly supported with respect to said support ring.

Preferably said tube passes between said support ring and said first opposed surface of said clamp and said drive portion of said clamp is located between said actuator disc and said tube.

Preferably said restrictor includes a sealed cover enclosing a all open side of said support ring facing away from said tube.

Preferably said piezoelectric drive means is enclosed between a sealed cover and said flexible substrate.

Preferably said flexible substrate is of metal.

Preferably said flexible substrate has a dome shape in an undeflected condition.

Preferably said flexible substrate is formed from at least two layers of different coefficients of thermal expansion.

Preferably said substrate comprises at least two metal layers of different coefficients of thermal expansion, and in said undeflected condition a said layer is under tension and another said layer is under compression.

Preferably said flattened section of said tube has a reduced wall thickness compared with portion of said tube adjacent the ends of said tube.

Preferably said actuator includes a piezoelectric material and the actuator either contracts or allows expansion of said flattened section of said tube when a voltage is applied across said piezoelectric material, and maintains this altered state while said voltage is maintained across the material.

In a further aspect the invention may broadly be said to consist in a refrigeration system including a variable restrictor between a high pressure energy shedding side and a low pressure energy absorption side, said variable restrictor being as set forth above.

In a still further aspect the invention may broadly be said to consist in a refrigeration system including a variable restrictor between a high pressure energy shedding side and a low pressure energy absorption side, said restrictor including
a flow path having a movable flow control element movable through a first distance between an open position and a closed position,
an actuator including a drive member acting on said flow control element having available travel between a first position and a second position that matches said first distance, said actuator including a piezoelectric material to move said drive member; and
a controller connected to apply a variable voltage across said piezoelectric material such that at a first voltage level said movable flow control element is in an open position and at a second voltage level said movable flow element is in said closed position.
said open position corresponding to a flow resistance equivalent to between 1.5 m of 0.91 mm inside diameter capillary tube and 5.0 m of 0.66 mm inside diameter capillary tube.

In a still further aspect the invention may broadly be said to consist in a variable restrictor as set forth above in a refrigeration system.

Preferably said refrigeration system includes a pump for moving refrigerant around a refrigeration circuit including said variable restrictor and a controller arranged to control the pumping capacity of said pump (for example by varying the speed and/or stroke of the pump) and arranged for controlling said actuator of said variable restrictor.

Preferably said controller receives input signals from at least one sensor connected with said refrigeration circuit, and from at least one sensor in a refrigeration location and coordinates pumping capacity of said compressor and actuation of said actuator of said variable restrictor in a response to signals received from said sensors.

Preferably said refrigeration system includes air movement means (such as a fan) for (generating a flow of air over a heat exchanger and the energy absorption side of said refrigeration system, said controller being arranged to control the capacity of said air flow generator.

In a still further aspect the invention may broadly be said to consist in a refrigeration appliance comprising an insulated enclosure, and a refrigeration system as set forth above.

This invention may also be said broadly to consist in the parts elements and features referred to or indicated in the specification of the applications individually or collectively, and any or all combinations of any two or more of said parts, elements or features, and where specific integers are mentioned herein which haste known equivalents in the art to which this invention relates, such known equivalents are deemed to be incorporated herein as if individually set forth.

### BRIEF DESCRIPTION OF THE DRAWINGS

One preferred embodiment of the present invention will be described with reference to the accompanying drawings.

FIG. 1 is a cross-sectional side elevation through a variable flow valve according to a preferred embodiment of the present invention.

FIG. 2 is a cross-sectional end elevation of the valve of FIG. 1 taken through line FF of FIG. 1.

FIG. 3 is a cross-sectional plan elevation of the valve of FIG. 1 taken through line TT of FIG. 1.

FIG. 4 is a perspective view of the external appearance of the valve of FIG. 1.

FIG. 5 is an end view of the valve of FIG. 1.

FIG. 6 is a graph illustrating the hysteresis performance of a single piezoelectric element as used in the exemplary embodiment of the present invention.

FIG. 7 is a graph illustrating the hysteresis performance of a prototype valve according to the present invention.

FIG. 8 is a cross-sectional side elevation of a domed actuator disc according to an aspect of the present invention.

FIG. 9 is a graph illustrating the deflection and related load achieved by alternative actuator embodiments, actuator 1 being a stacked piezoelectric bending element actuator, actuator 2 being a domed disc embodiment according to the preferred embodiment of the present invention.

FIG. 10 is a graph illustrating the contribution of bimetallic effect to flow output of the expansion device for a range of tested combinations.

FIG. 11 is a graph illustrating a relationship between preload force and available deflection for a sample actuator.

FIG. 12 is a diagrammatic representation of a step in the process of forming a flow tube for the valve of the present invention.

FIG. 13 is a graph illustrating the performance of a Sankyo stepper motor based variable flow valve for comparison purposes.

FIG. 14 is a graph illustrating the performance of a prototype valve according to the present invention.

FIG. 15 is a set of graphs illustrating the performance of a prototype valve according to the present invention at different pressures.

FIG. 16 is an alternate representation of the same information as the graph of FIG. 15.

FIG. 17 is a diagram illustrating a preferred refrigeration system incorporating an expansion device according to the present invention. Alternative aspects include a secondary air flow control device which in use would be located within the refrigeration space in a multiple compartment refrigerator.

FIG. 18 is cross-sectional side elevation of a single temperature refrigerator incorporating a refrigeration system as illustrated in FIG. 17.

FIG. 19 is a cross-sectional front elevation of the refrigerator of FIG. 18.

FIG. 20 is a cross-sectional side elevation of a dual temperature refrigerator incorporating a refrigeration system as illustrated in FIG. 17.

FIG. 21 is a cross-sectional front elevation of the refrigerator of FIG. 20.

### DETAILED DESCRIPTION

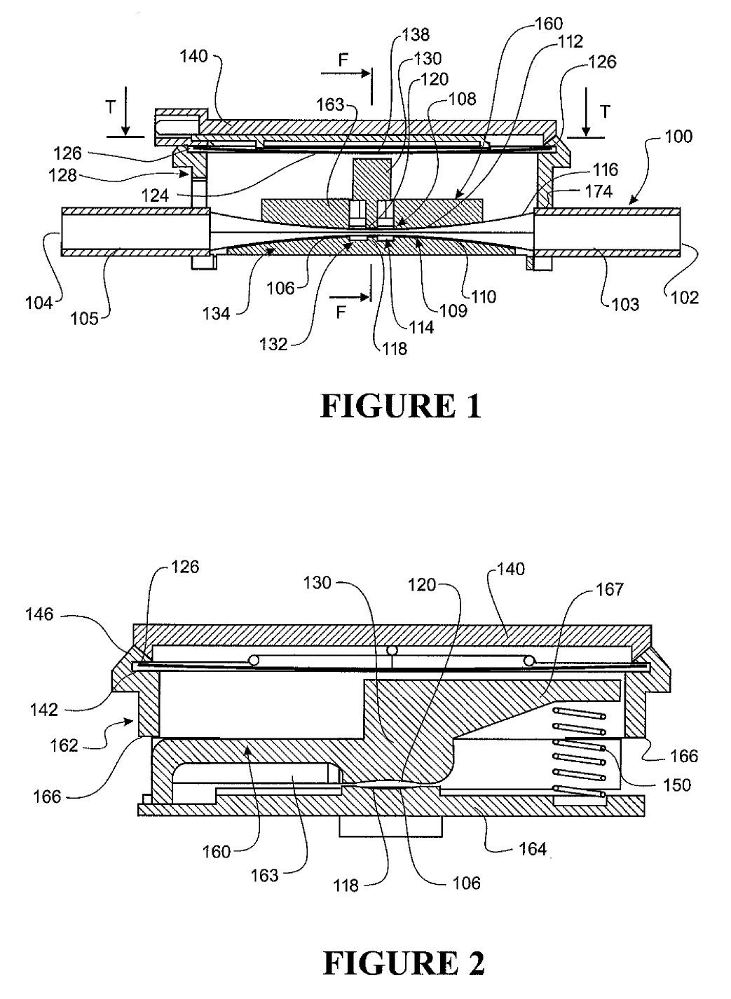

One illustrated embodiment of expansion device of the present invention will be described with reference to FIGS. 1 to 5. This embodiment includes the essential elements of the invention and illustrates additional features of preferred implementations or the invention.

Referring to FIG. 1 the expansion device includes a tube 100. The tube 100 is preferably formed from a material having a high modulus of elasticity. For example a stiff metal material such as heat treated steel or brass is preferred. Ideally the material is not susceptible to fatigue.

The tube has ends 102 and 104. When installed in a refrigeration circuit and the refrigeration circuit is operating one of these ends will be acting as an inlet end and the other end will be acting as an outlet end. Many refrigeration systems, for example in air conditioners, are configured to operate in either direction such that each heat exchanger in the system may operate as either a condenser or evaporator. In that case the inlet and outlet ends of the expansion device in use will depend in which direction the refrigerant is flowing through the system.

Each end of the tube 100 is preferably of a size and material that is compatible with the tubing intended for conveying refrigerant within the refrigeration system. For example, the tube may be a heat treated steel tube of the same or similar diameter as the refrigeration tubing carrying refrigerant from the condenser or to the evaporator. This facilitates connection of the tube directly to the tubing of the refrigeration system using processes that are familiar to the refrigeration system manufacturer, such as brazing. Essentially the tube 100 becomes a continuous pair of the refrigeration circuit. The tube 100 could even be part of a continuous length of tube forming part of the refrigeration circuit, however processing this section of tube to an appropriate form for the valve may then be rendered impractical.

Between the ends 102 and 104 of the tube 100 is a region of reduced cross-sectional area. This region comprises a flattened section 106 of the tube. Preferably the flattened section of tube is in the nature of a progressive taper 116 from either end to a region of minimum cross-sectional area approximately at the middle of the flattened section. Opposed walls 108, 109 of the tube are much closer together in this region of minimum cross-sectional area than in the unflattened tube.

An actuator is arranged to selectively alter the spacing of opposed walls 108, 109. In the preferred form the actuator is arranged to pinch the flattened section of tube by pressing together on the outer surfaces of the opposed walls.

The flattened section 106 of tube preferably has a wall thickness substantially less than the wall thickness of the end portions 103, 105 of the tube. This lesser thickness may apply along the progressive taper 116. This may be achieved by, for example, a machining grinding, etching or abrading process from a tube of uniform wall thickness. The lower wall thickness of the flattened section reduces the actuation force required to vary the separation of the walls of the flattened section 106. Retaining the thicker wall section in the ends 103, 104 facilitates connection into the refrigeration system.

For example a suitable tube for a valve of this type may be a heat treated steel tube having a initial nominal wall thickness of 0.5 mm. The end portions of the tube remain at this nominal wall thickness. The flattened portion of tube may have a wall thickness of from 0.1 mm to 0.2 mm.

The thin wall section of the flattened section 106 must still contain the elevated gas pressure of the high pressure side of the refrigeration system in use. Preferably the thin wall section is supported by support surfaces 110, 112 of a surrounding housing. The support surfaces are preferably substantially rigid, or at least incompressible, and are complementary to the exterior form of the flattened tube. A small span 114 of the tube wall may be unsupported at the location of the actuator.

The support may be from a series of supporting ribs or similar, rather than a continuous surface. The support may be provided by an incompressible liquid or gel surrounding the tube in a rigid enclosure.

Each end portion of the tube 103, 105 is preferably supported by the housing at the point that it exits the housing.

The actuator preferably includes a clamp with a pair of opposed faces 118, 120 on opposite sides of the flattened tube section 106, and an actuator for varying the separation of the surfaces of the clamp. The clamp may be a single component or group of components assembled to operate together. The clamp may be configured to have a neutral position in which the clamp partially compresses the flattened section 106 of the tube. The actuator is preferably able to operate the clamp in a first manner to allow expansion of the flattened section and in a second manner to compress the flattened section.

The preferred actuator comprises a piezoelectric actuator having a first portion fixed relative to one of the clamp surfaces and a second portion arranged to control movement of the other clamp surface. The first and second portions of the piezoelectric actuator move relative to one another with application of a voltage to the piezoelectric material. Preferably the actuator is designed so that application of a voltage causes the clamp surfaces to move together, while a voltage of the reverse polarity causes the clamp surfaces to move apart.

The preferred piezoelectric actuator includes piezoelectric elements fixed to a flexible substrate, with the flexible substrate connecting (directly or indirectly) between elements of the clamp. Operation of the piezoelectric elements causes deflection forces in the substrate and these deflection forces are transmitted to the clamp.

The preferred substrate is a circular disc 124 supported at its rim 126. The rim 126 of the substrate may be supported by a housing 128 of the expansion device. The substrate is preferably supported substantially continuously around its rim.

The circular disc 124 is preferably arranged for deflection either toward or away from the tube 100. However the clamp could be arranged to translate movement in other axes to movement of the clamp surfaces toward and away from the tube.

A moving clamp portion 130 is preferably supported in the housing 128 to move toward or away from the flattened portion 106 of the tube. A fixed clamp portion 132 is located on the opposite side of the tube to the moving clamp portion 130, and is supported so as to be in a fixed position relative to the rim 126 of the substrate. The fixed clamp portion may comprise part of a housing component that supports the rim of the disc. However preferably the lower clamp portion is fitted into place in the housing alter the tube 100.

In the illustrated embodiment of the invention a centre portion of the disc substrate is positioned to act against an upper surface of the moving clamp portion. The disc or clamp portion may include a small pin or knob for creating a local contacts. For example a short pin 138 protrudes from the lower face of the disc 124. The size of the moving clamp portion and the spacing of the centre portion of the disc substrate away from the tube 100 are preferably set so that with no voltage applied to the piezoelectric elements the actuator presses the moving clamp element against the tube to a predetermined degree.

A biasing element may press the movable clamp element 130 against the disc substrate to preload the piezoelectric elements to a predetermined degree. The biasing element may for example be a spring 150 acting between a base of the housing the movable clamp member.

The disc 124 carrying the piezoelectric elements 125 is preferably domed. The dome of the disc preferably extends toward the flattened portion of the tube.

The piezoelectric elements may be on the concave or convex side of the disc. Preferably the elements are on the side of the disc facing away from the movable clamp member 130. This allows for more piezo elements on the disc without interfering with the area of the disc that contacts the movable clamp member. Preferably this is the concave side of the disc.

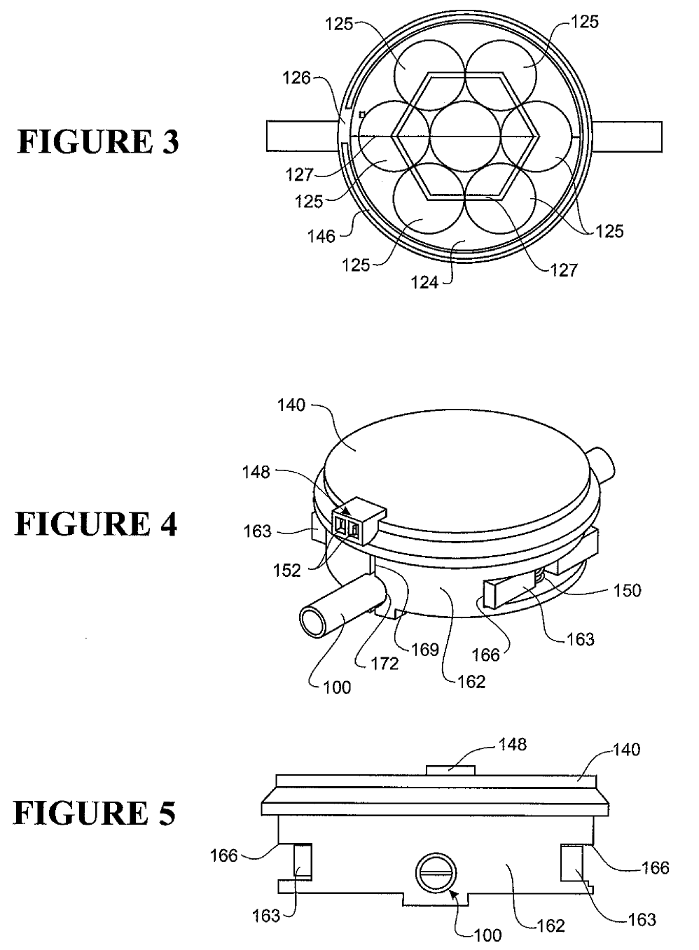

The piezoelectric elements may for example be a piezoceramic material such as PZT-51 available from Annon Ultrasonic Electronic Technology Company of China. An arrangement of circular piezoelectric elements 125D on the concave side of the preferred domed disc 124 is illustrated in FIG. 3. The elements have a sandwich construction and include conductive electrodes on either planar surface. Electrical connections are provided to these elements on one surface by the conductive substrate to which they are secured. The substrate is in turn connected at its rim 126 to an input lead. Electrical connections are provided to the elements on the outwardly facing surface, for example by a network of conductors 127 connecting between elements, and leading to a second input lead. The elements 125 all operate in parallel so that the same voltage is applied between the inner face and the outer face of each element.

In the preferred refrigeration appliance the valve is located in the cold space of the appliance This can be a difficult environment with ice buildup on the system components, and subsequent water presence during defrosting.

To prevent moisture ingress to the piezoelectric elements the disc 124 is preferably coated with a suitable barrier such as a resin varnish or lacquer used for sealing electrical circuits in other applications. In addition, a cover portion 140 of the housing may be fitted over the actuator disc closing an upper portion of the housing 128.

The periphery 126 of the actuator disc substrate 124 is preferably located within an annular inwardly facing channel 142 at the upper edge of a cylindrical wall 144 of a housing. The housing 128 preferably includes a cover 140. The channel 142 holding the periphery of the actuator disc 124 preferably includes an inwardly extending upper flange 146. The cover 140 preferably closes against this upper flange 146. An electrical connector 148 is provided at the edge of the cover 140 for making a wiring connection to the disc actuator. One of the contacts 152 of the connector is in electrical conductive relationship with the substrate 124 of said actuator disc. The other of the contacts 152 of the connector is in electrical conductive relationship with the outwardly facing surfaces of the piezoelectric elements 125. Alternatively a lead may extend directly from the disc actuator, having sufficient length to reach a control unit.

Preferably the movable clamp member 130 comprises a part assemblers into the housing. Alternatively the movable clamp member may be integral with the housing, for example connected with the housing by an extended flexible arm or living, hinge.

The housings including cover, movable clamp member, fixed clamp member and tube support surfaces may be produced as multiple parts for subsequent assembly. Alternatively these parts may be produced as a single part, for example, by a moulding process. However, the illustrated design could not easily be moulded as a single part capable of accepting the tube 100.

Preferably the moveable clamp member and the fixed clamp member are made by moulding a stiff material such as reinforced plastic. Alternatively the clamp members may be made of metal to provide structural stiffness. The housing may be moulded from any suitable plastics material.

The movable clamp member may, instead of having a flexible integral connection with the housing, have a pivoting hinge connection with the housing, or a sliding support within the housing. With a hinging connection with the housing, the arm between the hinging connection (whether integral live hinge type hinging or pivot point type hinging) and the clamp surface of the movable clamp member preferably has a sufficient length that movement of the clamp surface in the location of the flattened portion of the tube is substantially linear and perpendicular to the axis of the tube.

A first component 160 may include the movable clamp member 130 (with clamp surface 120) and the upper support surface 112 for the flattened portion of tube. A flexible joint and arm may connect between the movable clamp member 130 and an upper support member 163 that includes the support surfaces 112. A second component 162 may include the cylindrical wall of the housing. A third component 164 may include a base portion of the housing including a lower clamp surface 118 and the lower support surface 110 for the flattened portion of the tube. The first component 160 may be held within the body 162 of the housing with ends held inside opening 166 in the cylindrical wall of the housing. The first component 160 may be located by suitable fasteners, adhesives, welding, or integral clips having complementary shapes formed in the first component 160 and the cylindrical wall component 162. The third component 164 may be fitted to close the underside of the cylindrical body 162. This component 164 may be located by suitable fasteners, adhesives welding or integral clips.

Where the tube ends 103, 105 enter and exit the cylindrical wall of the housing, one or both exit points may be configured to be capable of expansion to assist with assembly of the valve device, or shaped to allow the flattened portion of the tube to pass. For example the cylindrical wall of the housing may include a vertical slot 169 extending from one side of the aperture 172 for receiving the tube.

The device in the form illustrated in FIGS. 1 to 5 may be assembled according to the following process. First the expandable opening 172 of the cylindrical wall is expanded. The flattened tube may then be introduced to the second component 162 through the expanded opening, to span across the space within the cylindrical component, with one of the end portions passing out through the other side of the housing through its associated aperture 174.

Next the third component 164 including the base portion and distal support surfaces 110 is fixed to the lower edge of the cylindrical wall component 162. This substantially encloses one open end of the housing. Preferably clips integral to the third component and the cylindrical wall engage to hold the third component in place.

The first component 160 including the upper Support surfaces 112 and the movable clamp member 130 may be introduced through the open top of the housing, prior to enclosure by the actuator disc. Ends of the support member 163 of the first component 160 may snap fit into place in openings 166 of the second component 162.

The actuator disc may then be clipped in place in peripheral support channel 142 at the top edge of the cylindrical wall.

Preload spring 150 is then inserted through a side opening a of the cylindrical wall to act between the base portion of the third element 164 and an extended arm 167 of the movable clamp member 130.

The cover 140 may be fitted to the upper edge of the housing once the actuator disc is properly located.

Preferably at least one of the clap surfaces 118, 120 pressing against opposite sides of the flattened section tube is a narrow wall or knife comparatively narrower in the length dimension of the tube than its length in the width direction of the tube.

### Expected Pressure Drop

When a viscous fluid flows through a constriction defined by a pair of close plates, the pressure drops according to the following equation

$$δ P = 12 \cdot μ \cdot m \frac{l}{a \cdot ρ \cdot {h}^{3}}$$

δP-=pressure drop
μ=viscosity of the fluid
m=mass flow
p=fluid density
l=length of the restriction area (design variable)
a=width of the restriction area (design variable)
h=gap between two plates (varied by actuator)

It can be seen that by carefully choosing a and l the range of h between intended maximum and minimum values of δP can be selected to suit a chosen piezoelectric actuator.

### Tube Deformation

In the device of the present invention the expansion tube is deformed elastically. For maximum displacement of the tube for a given actuator design, high stiffness of the actuator and low stiffness of the tube is preferred. The total available displacement is related to the stiffness of the tube and actuator according to the equation

$$L = {L}_{0} ( \frac{{K}_{a}}{{K}_{a} + {K}_{l}} )$$

L=displacement with changing external load
L₀=displacement without external load
Ka=Stiffness of the actuator
Kl=Stiffness of the load

For the tube there is a trade off between decreasing stiffness and attaining, a safety reserve against internal pressure while maintaining good flow control.

The device comprises two key parts, a piezoelectric actuator and a restriction.

The primary design parameters that characterize any linear actuator are displacement, force, frequency, size, weight and electrical input power. Most actuators usually perform well in some of these categories but are poor in others.

For our preferred application in a refrigeration system, the piezoelectric actuator preferably provides 30 to 100 μm displacement at a changing load. The force range is typically from 0 to 15N.

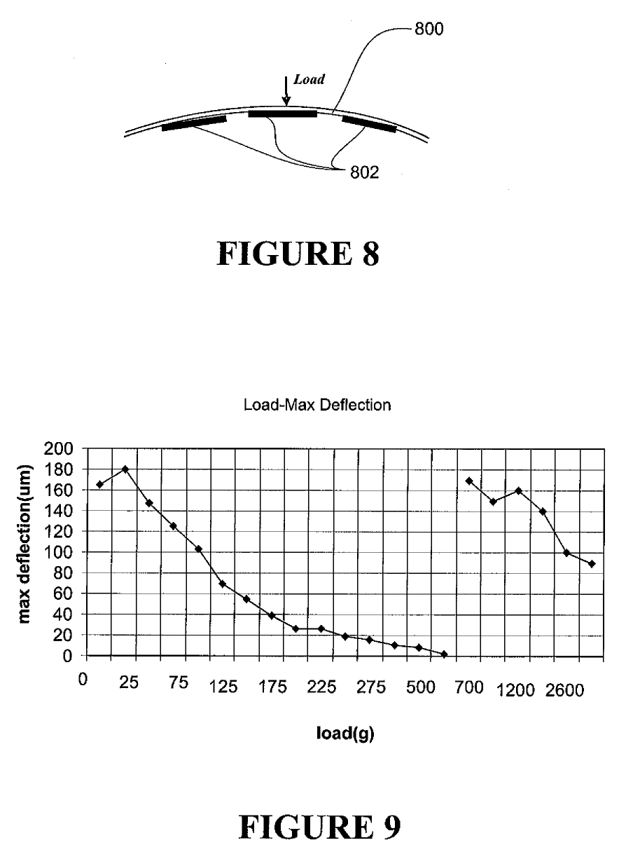

The preferred actuator is a domed bending disc actuator, as illustrated in FIG. 8.

This actuator is manufactured according to the following method. A bimetal disc 800 is made by bonding a brass disc to a steel disc at elevated temperature. This bimetal disc forms a dome when cooled from the curing temperature. A set of piezoelectric elements 802 are glued onto the disc. Connecting wires are soldered to join the elements to provide power supply to one surface of the elements. The piezoelectric element side of the disc is coated with a suitable material to prevent humidity penetration. The piezoelectric elements are polarized, for example using a 2 KV/mm field for 20 minutes.

This preferred actuator was compared against an alternative actuator comprising a stack of piezo driven bending units, of smaller span. The followings table compares some key characters of two actuators we made.

TABLE 1

| | | | | | | Number of |
|---|---|---|---|---|---|---|
| | Block | Max | Driving | | Electrode | Piezo |
| | Force | Deflection | Voltage | Size (Diameter × Height) | lead out | elements |
| Stacked | <5 N | 180 um | −80 V, 80 V | 16 mm × 20 mm | Difficult | 10--20 |
| bending | | | | | | |
| actuator | | | | | | |
| Bending disc | 0-40 N | 170 um | −80 V, 340 V | 49 mm × 2 mm | Easy | 6-7 |

FIG. 9 shows the Force-Deflection curves for each of the two actuators.

Theoretically, the stacked actuator should Rive much higher displacement than 200 μm. However it appears that the gaps between the elements in the stack absorb most of the displacement. Also, when multiple layers are included, the block force is lower and the electrode arrangement becomes more complicated.

The performance of the bending disc actuator is more suitable for our application. Two key aspects in this design that improve the force performance are the domed disc and preloading for the actuator. The importance and reasons for the domed disc and preloading force are explained in the following sections.

From the testing results, the actuators with domed discs gave better performance than stacked elements. The inventors believe that the domed disc puts the piezo elements into compression. These ceramic elements behave better in compression than in tension. Furthermore the inventors believe that the geometry of the domed shape is excellent at balancing the preload force, leaving the piezo elements with a low stress where they can provide maximum movement per unit of voltage.

There are many ways available for manufacturing a domed actuator disc. Our preferred method involves preparing a bimetal disc at elevated temperature, and then allowing the disc to deflect as it cools.

In one example of this preferred method steel and brass discs with the same diameter are bonded together by high strength resin at 160° C., the highest temperature the example adhesive (LOCTITE Fixmaster High Performance Epoxy) can stand. The disc is then allowed to cool down to room temperature. The different coefficient of thermal expansion of these two metals leads to a domed disc at lower temperature. This bimetal effect is also exhibited in subsequent use, the dome becoming more exaggerated as the working temperature drops. With a proper arrangement of the disc the bimetal effect may add to the deflection of piezoelectric units.

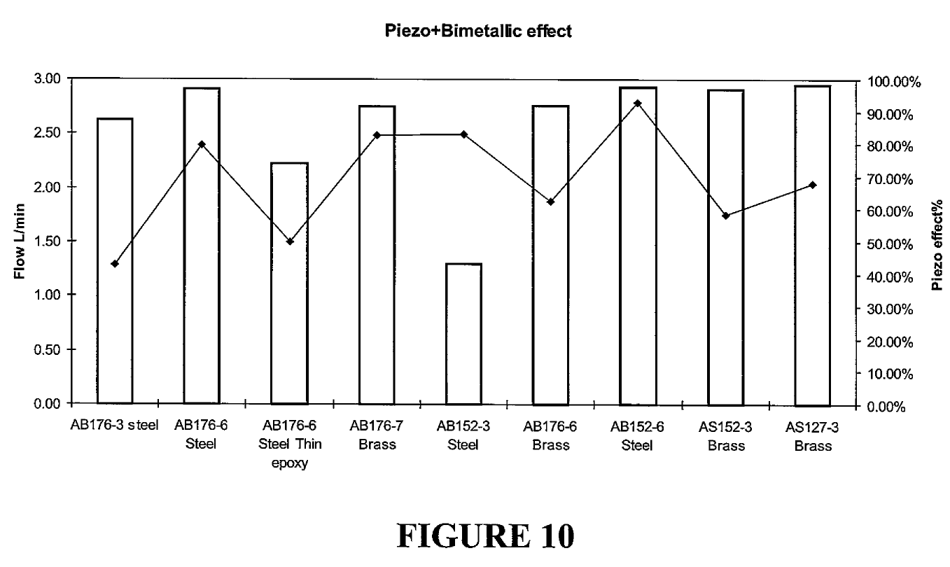

FIG. 10 shows the performance of a series of bimetal piezoelectric-variable expansion devices. The nitrogen flow change at 200 kpa was measured by driving the actuator and changing the ambient temperature. From 15° C. to −20° C., the bimetal effect works together with the piezoelectric effect. The percentage numbers shown are the contribution from the piezoelectric voltage. So with a weaker piezoelectric actuator, the bimetal disc could contribute as high as 57.25% of the total control.

The bimetal effect is a byproduct of the dome disc manufacturing method, involves no extra cost consumes no input energy in operation. However the bimetal effect is not an active control. The effect is driven by the environment temperature and sometimes may work against the desired actuation direction.

The experiments performed by the inventors also indicate that a performance advantage is obtained by preloading the actuator.

This preloading force will squeeze out any gaps in the assembly, will strain the adhesive layers and will press down the disc to a preferred shape.

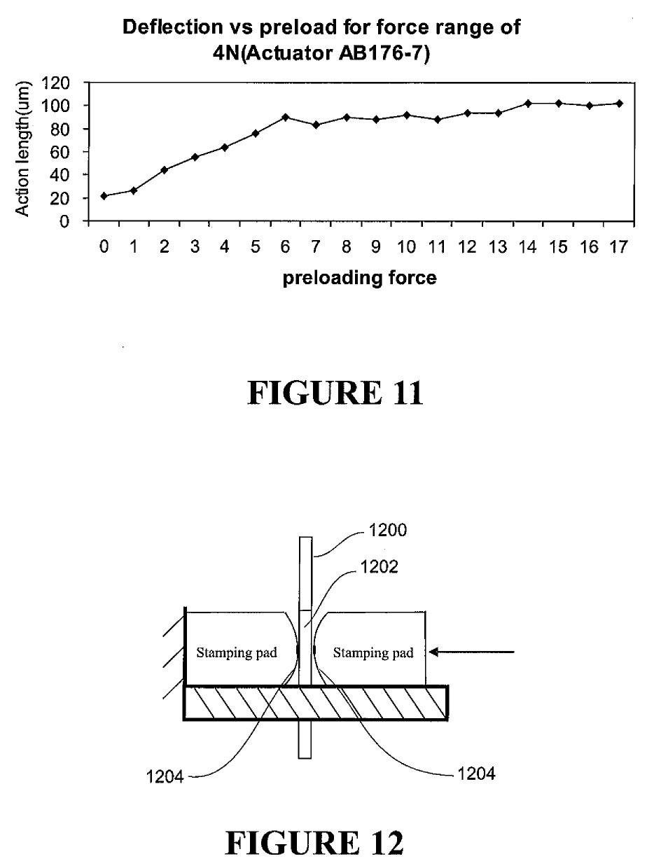

In one test, the results of which are shown in FIG. 11, for the same actuator (AB176-7) and force change (4N), the actuator displacement changed from 22 um without a preloading force to be around 100 um where the preloading force was bigger than 15N.

To choose a suitable preloading force for the actuator, the valve tube may be tested under pressure to obtain information regarding the force range and displacement needed for required flow control. The actuator may then be tested to obtain the desired preloading force. Although a higher preloading Force often results in higher displacement, a high preloading force is not always preferred because the preload force increases the mechanical load of the actuator and reduces the life time of the piezoelectric units. For example, the AB176-7 actuator can reach 90 um at a preloading of 7N, and can reach 100 um at a preloading of 15N and higher. If 90 um displacement is sufficient for the tube to control the flow in required ranges 7N preloading force is preferred to 15N as the lower preload force may impact less on the life time of the device.

### Preferred Actuator Design

The preferred commercially available piezo elements are circular and have a diameter of 15 mm and thickness of 0.2 mm.

On the preferred dome bending disc an arrangement of seven piezo elements may be applied on brass side, or an arrangement of six piezo elements may be applied on the steel side. The actuator driving tip is mounted on the top of the dome at the center of the steel disc, so there is no space for a central piezo element on steel side.

The preferred bimetal disc has a diameter of 49 nm. The ratio of steel and brass discs thickness tₛₜₑₑₗ/t_{brass} was kept at around 1.2. In tests conducted by the inventors the best performed actuators had their steel disc thickness of 0.176 mm and brass disc thickness of 0.203 mm

The preferred arrangement of piezoceramic elements on the disc is illustrated in FIG. 3.

### Tube

To get the best performance from the valve the valve tube should match the performance of actuator. This suggests using a tube of low stiffness. Practically, pressure safety standards demand a minimum wall strength, so there is a lower limit to tube “stiffness”.

Brass tube is preferred because it can be easily thinned and stamped to the desire shape, has relatively high strength and fatigue life, and can be brazed to the rest of the refrigeration system. Other possible tube materials include steel and copper.

The outer diameter and the wall thickness of the tube are preferably chosen to obtain required stiffness and flow control. The outside diameter and wall thickness will determine the stiffness of tubes made from same material and made using the same process. Generally, the tube with thicker wall and smaller outside diameter will stand higher pressure but have higher stiffness and be harder to form.

For the same wall thickness, a tube will be softer with increasing outside diameter, which is easier for the actuator to work. But performance of a larger tube is worse in the low-flow range because it is more difficult to shut down.

After a series of tests the inventors consider that it may be difficult to safely thin the wall of suitable brass tube to less than 0.1 mm. A brass tube having a wall thickness of 0.15 mmin the thinned region provided stable quality tubes. For this wall thickness, the tubes with outside diameter smaller than 3/16 inch were stiffer for our preferred actuator. Tubes having outside diameter larger than ¼ inch gave worse performance operating with low flows. A brass tube having outside diameter between 7/32 inch and ¼ inch thinned to 0.15 mm wall thickness, has proven suitable for controlling the flow of a test gas within a desirable flow range of N₂ from 0.5 L/min to 5 L/min under 200 kpa at room temperature.

Samples of the preferred tube may be manufactured according to the following method. A section 1202 of a brass tube 1200 is thinned and polished to desired wall thickness by sandpaper. The brass tube is annealed at 600° C. for 1 hour in nitrogen. The thinned section of the tube is stamped in a clamp having end faces 1204 with the desired shape as illustrated in FIG. 12 to provide a transverse flow constriction. The tube is heated to 400° C. for 20 minutes to relieve stress. The tube is heat treated, for example by heating to 300° C., then quenching in water followed by heating to 600° C. and quenching again.

### Tested Prototypes

The inventors have tested prototype variable restrictors including domed actuator discs and thinned valve tubes. Each variable restrictor was installed on a vice so that the flow range could be changed by adjusting the vice.

The power supply for the test consisted of a variac, a DC transformer and a relay. The power supply could provide an adjustable DC voltage from −340 to 340V, A multimeter was connected to monitor the voltage applied to the piezoelectric actuator.

The flow of the N₂ gas was measured by a set of flow meters.

### Driving Method

### Voltage Range

The piezoelectric units are driven by an asymmetric bipolar voltage. In the direction of polarization the maximum allowable voltage for the selected piezoelectric elements is 500V. In the other direction, the element is limited to 120V before depolarization starts. In practice, for longer lifetime of the device the driving range is preferably restricted to the range −80V to 340V.

### Highest and Lowest Flow Position

The typical actuator used in our tests had the piezoelectric elements attached on the brass side (concave side) of the dome. This arrangement provides for highest flow at −80V and lowest flow at 340V. For actuators with the piezoelectric elements on steel side, the restrictor provides highest flow at 340V and lowest flow at −80 V. This latter design ma) be more suitable for a refrigerator where most of the time is spent with low flow.

### Calibration

The traditional method of testing refrigerator capillaries is to measure the flow rate of high pressure dry Nitrogen. To calibrate or set up a new restriction the following (method could be used:
setting the test gas source pressure, for example, at 200 Kpa;
adjusting the variac and relay to put the restrictor at highest flow output (for example −80V or 340V according to the actuator); and
adjusting to set the flow at the highest flowrate required, say 3 L/min for 200 kpa.

### Performance

### Flow Control

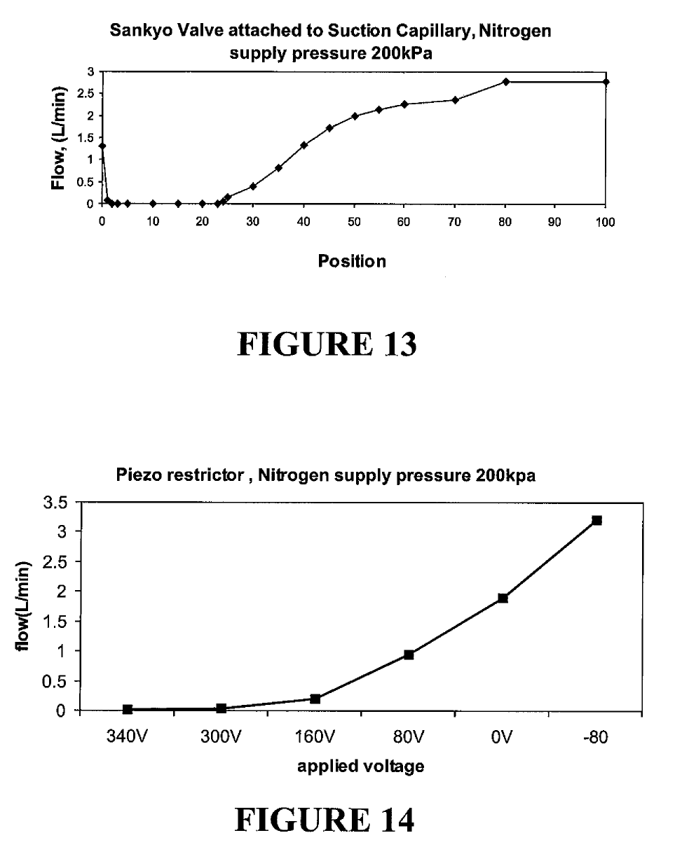

FIG. 13 shows the performance of a typical stepping motor controlled valve that the expansion device of the present invention must compete with.

FIG. 14 shows the performance of a piezoelectric restrictor according to the present invention. This piezoelectric restrictor could control flow from 0.023 L/min to 3.2 L/min which overlapped most of the flow range of the stepping motor valve. However, this restrictor was unable to shut the flow down to zero.

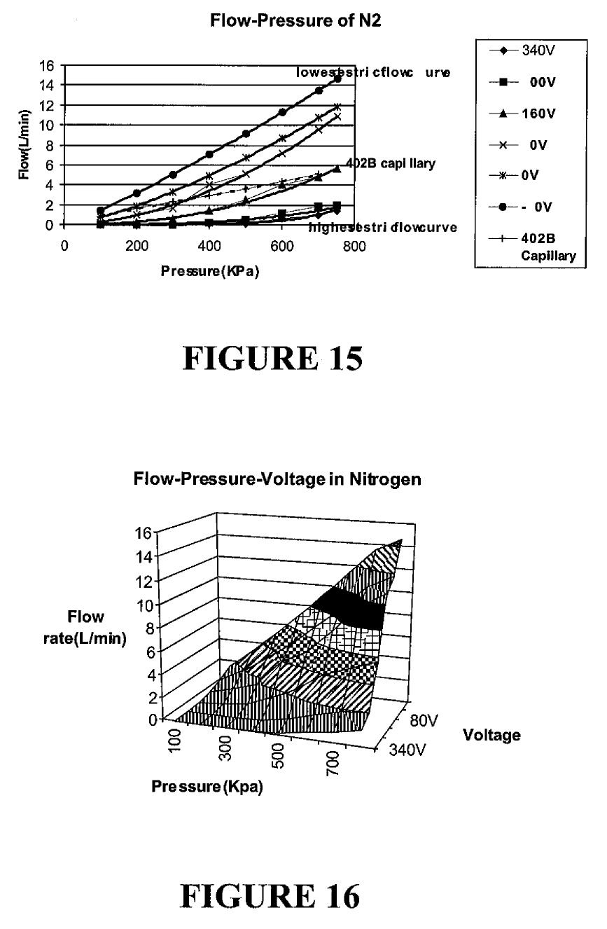

FIGS. 15 and 16 are measured working charts of one of the tested piezoelectric restrictors tested at different pressures.

These piezoelectric restrictors severe able to fully cover the working range of a typical domestic refrigeration system. It can not shut off the flow completely, like the stepping motor valve, but neither does a capillary. If full shut off of the flow is not required, the piezoelectric variable restrictor will be an acceptable flow control.

### Reliability

### Testing

One of the piezoelectric restrictors was tested at its extreme working condition (340V, 750 kpa). The gas flow was well held at around 60 ml/min for two weeks. There were no adverse effects.

Several prototype restrictors put into a refrigeration testing rig failed after several cold-warm cycles. The failures were triggered by very serious condensation. The coating on top of the piezoelectric elements in those restrictors was insufficient to prevent the water invasion. After the moisture entered the 0-2 mm thick ceramic elements arcing occurred in the 1.7 KV/m electric field. The inventors propose a construction of mechanical cover together with a more suitable coating to overcome this problem.

There is no formula to determine the lifetime of a piezoelectric actuator because there are too many influential parameters, such as temperature, humidity, applied voltage, load, frequency and insulation. The life time of a piezoelectric ceramic is not limited by wear and tear. As a capacitor, working in a given environment the lifetime of piezoelectric ceramic is a function of the applied voltage. Ideally the average voltage should be kept as low as possible. Tests have shown that piezo elements can run excess of 10⁹ cycles without loss of performance under suitable conditions.

Piezoelectric actuators have advantages like quick response speed, large forces in compact size and precise response. However for open loop application, there are some aspects of their behaviour including hysteresis and creep that can affect their performance.

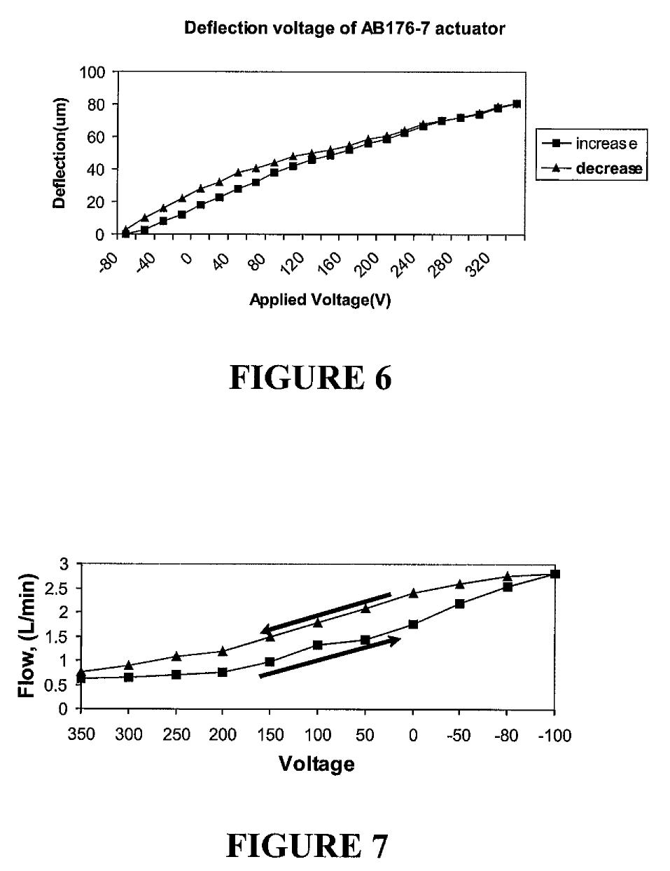

Open loop piezoelectric actuators exhibit hysteresis. Hysteresis is based on crystalline polarization effects and molecular effects. The absolute displacement generated by an open-loop piezoelectric material depends on the applied voltage and the piezoelectric gain, which is related to the remnant polarization. The remnant polarization, and therefore the piezoelectric gain, is affected by the electric field applied to the piezoelectric material, so the deflection depends on whether the material was previously operated at a higher or lower field strength. Hysteresis is typically on the order of 10% to 15% of the commanded motions. This is illustrated in FIGS. 6 and 7.

Creep is the expression of the slow realignment of the crystal domains in a constant electric field over time. The creep is related to the effect of the applied voltage on the remnant polarization of the piezoelectric ceramics. If the operating voltage of a piezoelectric material is changed, after the voltage change is complete, the remnant polarization continues to change, manifesting itself in a slow creep. The rate of creep decreases logarithmically with time.

### Refrigeration Systems Incorporating the Expansion Device

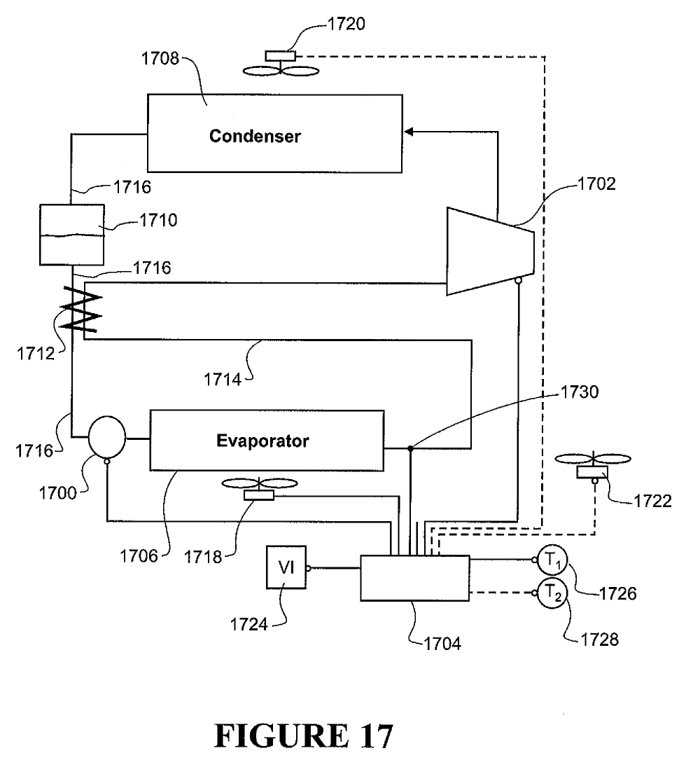

FIG. 17 illustrates in schematic form a refrigeration system including an expansion device 1700 according to the present invention. The preferred system includes a compressor 1702 of variable capacity, such as a linear compressor in which the stroke may be controlled, or a pump adapted to run at variable speed, and a controller 1704 controlling operation of the compressor 1702 and the valve 1700.

The controller may communicate with independent drive circuits for the compressor and/or valve, for example using a generic network interface to communicate with an independent electronic controller for each element. Alternatively the controller may provide direct control voltages for the piezoelectric elements of the valve and/or for the motor of the compressor.

As well as these core components the preferred refrigeration system includes the usual evaporator 1706 and condenser 1708. The expansion device 1700 is included in series between the condenser 1708 and the evaporator 1706. The compressor is included in series between the evaporator 1706 and the condenser 1708.

A receiver 1710 may be provided between the condenser 1708 and the expansion valve 1700. This ensures that the expansion device is; supplied with a steady flow of liquid refrigerant.

A suction line heat exchanger 1712 may be provided to operate between the suction line 1714 leading from the evaporator 1706 to the compressor 1702, and the condensed refrigerant line 1716 between the condenser 1708 and the expansion device 1700. The suction line heat exchanger 1712 transfers heat from the hot liquid refrigerant to the cold gases returning to the compressor. This tends to increase the efficiency of the overall system and reduces any change of liquid refrigerant reaching the compressor.

The controller 1704 may also control operation of one or more fans. Each fan may be controlled either to turn on or to turn off, or may be run at a controlled speed.

Sometimes a fan 1718 will be provided for forcing a flow of air over the evaporator in the cold space of the appliance. This fan may also serve to circulate air within the cold space.

An additional fan 1720 may provide forced convection over the condenser.

Single evaporator refrigeration systems may also be used in a dual temperature appliance. For example typical dual temperature appliances have a first compartment (cooler) at around 2C and a second compartment (freezer) at around −18C. In these systems a second fan (e.g. 1722), damper, or other air flow control may be provided to direct a portion of air cooled by the evaporator to the higher temperature compartment. The controller may integrate control of this secondary air flow control device with control of the compressor, the variable expansion device and the evaporator fan.

The controller typically receives input data concerning desired compartment temperatures from a user interface 1724. Further input data may be sourced from a temperature sensor 1726, 1728 in each cold compartment. Still further input data may be sourced from a suction line temperature sensor 1730. As well as these the controller may receive feedback data from any of the controlled devices, including the evaporator fan and compressor.

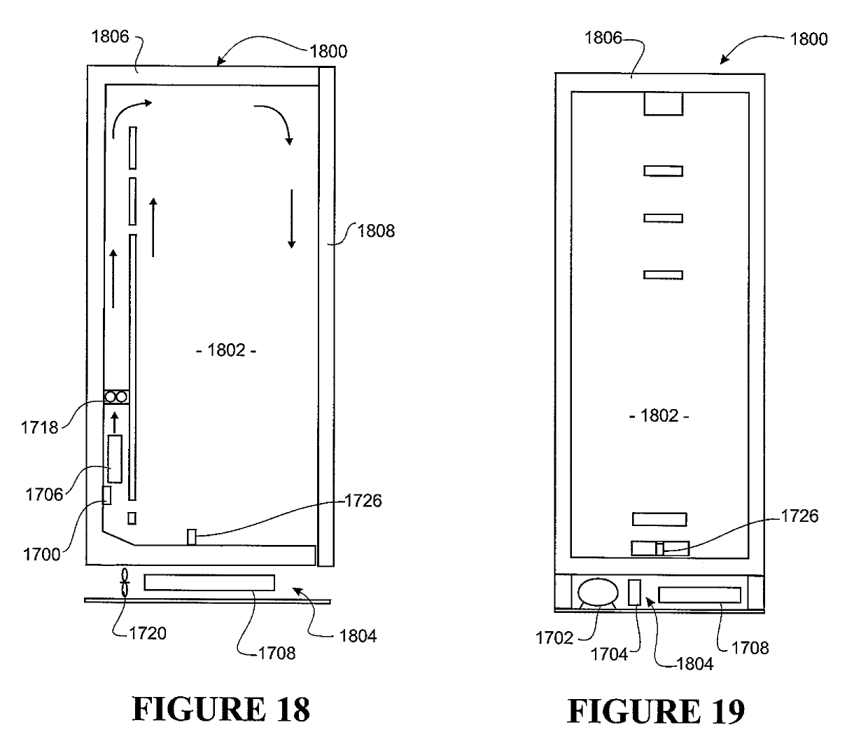

FIGS. 18 and 19 illustrate a single temperature refrigeration appliance 1800 including a refrigeration system that uses the valve of the present invention. The appliance includes an insulated cabinet 1806 enclosing a cooling space 1802. A door 1808 provides access to the cabinet. Alternatively the cabinet may house a series of drawers, or a number of divided spaces with separate doors. A wide range of configurations are known in the art.

The compressor, condenser and accumulator are located outside the coolings pace, such as in an equipment bay. The equipment bay 1804 may be below the insulated cabinet of the appliance. An evaporator 1706 is provided within the insulated cold compartment 1802 of the appliance. The expansion device 1700 is located in the cold compartment, preferably in the vicinity of the evaporator 1706. Preferably an actively controlled fan 1718 blows air at selected flow rates across the evaporator in use. The controller 1704 controls the compressor 1702, the expansion device 1700 and the speed of each fan 1718, 1720 according to the sensed condition in the cold compartment 1802 of the refrigeration appliance.

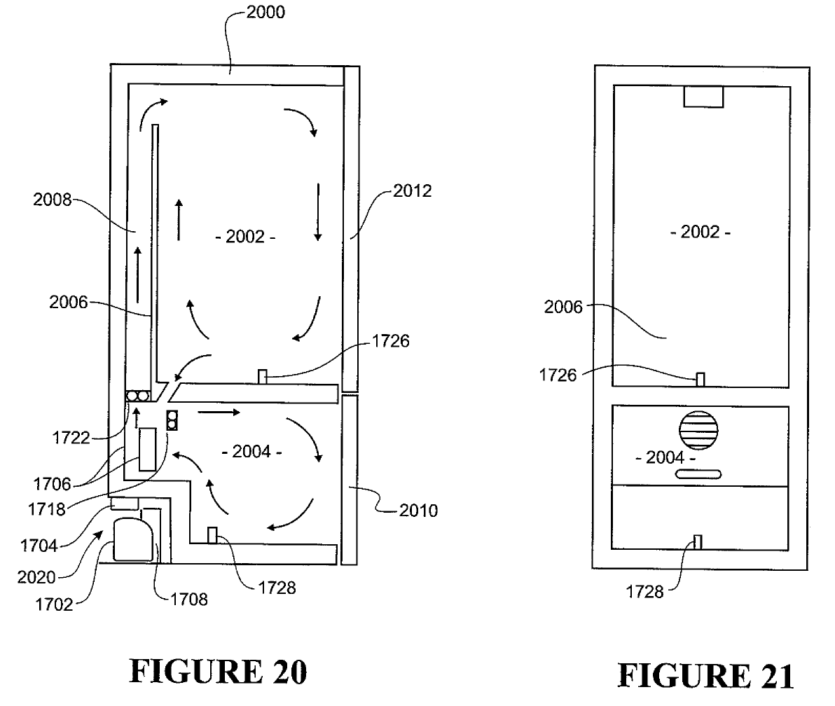

FIGS. 20 and 21 illustrate a dual temperature refrigeration appliance including a refrigeration system that uses the expansion device of the present invention. The appliance includes an insulated cabinet 2000. The cabinet 2000 encloses several compartments 2002, 2004. Compartments 2002, 2004 are insulated from each other A rear wall baffle 2006 divides a cold air flow 2008 from the compartments 2002, 2004. Doors 2010, 2012 close each compartment. As described above, a wide range of alternative configurations is knows in the art. The illustrated configuration is merely an example to show the expansion device of the present invention advantageously located in the cold space to take advantage of the bimetal effect associated with the preferred actuator disc.

The compressor, condenser and accumulator are located in an equipment bay 2020, for example at the lower rear of the appliance. All evaporator 1706 is provided within the lowest temperature compartment of the appliance. The expansion device 1700 is located in the vicinity of the evaporator. An actively controlled fan 1718 blows air at selected flow rates across the evaporator 1706 to circulate in the freezer space 2004. A second actively controlled fan 1722 selectively draws cold air from the freezer space to the higher temperature cold space. The controller 1704 controls the compressor 1702, the expansion device 1700 and the speed of each fan 1718, 1722 according to the sensed condition in each of the compartments of the refrigeration appliance.

For the preferred domestic refrigeration application the restrictor should have an open state that produces the desired pressure drop at highest capacity operation. For typical systems this will be equivalent to between 1.5 m of 0.91 mm diameter capillary tube and 5 m of 0.66 mm inside diameter capillary tube.

Then in the closed state the restrictor should present the smallest possible area. Ideally the restrictor should become completely closed, however a cross-sectional area below 50×10⁻⁹ m² would be useful compromise.

1. A variable restrictor comprising:
a tube having first and second ends of a first cross-sectional area and a region between said ends of reduced cross-sectional area, said region comprising a flattened portion of said tube where said tube has been permanently deformed such that opposed wall portions of said tube are much closer together than in the remainder of said tube, and
an actuator arranged to selectively alter the separation of said opposed wall portions of said flattened section.

2. A variable restrictor as claimed in claim 1 wherein said tube is of a metal.

3. A variable restrictor as claimed in claim 1 wherein said flattened section when uncompressed has a flow resistance between 1.5 m of 0.91 mm inside diameter capillary tube and 5.0 m of 0.66 mm inside diameter capillary tube.

4. A variable restrictor as claimed in claim 1 wherein the minimum cross-sectional opening area of said flattened section when in its most restricted state, is less than 50×10⁻⁹ m².

5. A variable restrictor as claimed in claim 1 wherein said opposed walls without forced displacement by said actuator are less than 100 micrometers apart.

6. A variable restrictor as claimed in claim 1 wherein said actuator is operable to pinch said flattened portion by pressing together on the outer surfaces of said opposed walls.

7. A variable restrictor as claimed in claim 6 wherein said actuator has an unactivated condition, and in said unactivated condition said actuator partially compresses said flattened section.

8. A variable restrictor device as claimed in claim 7 wherein said actuator is actuable in a first manner from said unactivated condition to allow expansion of said flattened section.

9. A variable restrictor as claimed in claim 7 wherein said actuator is actuable in a second manner from said unactivated condition to further compress said flattened section.

10. A variable restrictor as claimed in claim 1 wherein said actuator includes:
a clamp including opposed surfaces, said flattened section passing between said opposed surfaces,
a flexible substrate connecting between elements of said clamp such that deflection forces of said substrate are transmitted to said opposed surfaces, piezoelectric drive means fixed to said flexible substrate such that applying voltage to said piezoelectric drive means causes deflection forces in said substrate.

11. A variable restrictor as claimed in claim 10 wherein said piezoelectric drive means comprises multiple thin piezo elements distributed on a substantially planar surface of said substrate.

12. A variable restrictor as claimed in claim 10 wherein said flexible substrate comprises a thin disc and said piezo electric drive means is distributed over said disc.

13. A variable restrictor as claimed in claim 12 wherein the perimeter of said disc is supported by a support ring, said support ring having a substantially rigid relation with a first said opposed surface of said clamp, and a portion of said disc spaced from said support ring contacting a drive portion of said clamp that is substantially rigidly connected to the other said opposed surface but movable relative to said first opposed surface.

14. A variable restrictor as claimed in claim 13 including pressure support surfaces supporting the wall of said tube in the region adjacent said opposed clamp surfaces.

15. A variable restrictor as claimed in claim 13 wherein said drive portion of said clamp is flexibly supported with respect to said support ring.

16. A variable restrictor as claimed in claim 13 wherein said tube passes between said support ring and said first opposed surface of said clamp and said drive portion of said clamp is located between said actuator disc and said tube.

17. A variable restrictor as claimed in claim 13 including a sealed cover enclosing an open side of said support ring facing away from said tube.

18. A variable restrictor as claimed in claim 10 wherein said piezoelectric drive means is enclosed between a scaled cover and said flexible substrate.

19. A variable restrictor as claimed in claim 10 wherein said flexible substrate is of metal.

20. A variable restrictor as claimed in claim 10 wherein said flexible substrate has a dome shape in an undeflected condition.

21. A variable restrictor as claimed in claim 10 wherein said flexible substrate is formed from at least two layers, said layers including at least two layers of different coefficients of thermal expansion.

22. A variable restrictor as claimed in claim 20 wherein said substrate comprises at least two metal layers of different coefficients of thermal expansion, and in said undeflected condition a said layer is under tension and another said layer is under compression.

23. A variable restrictor as claimed in claim 1 wherein said flattened section of said tube has a reduced wall thickness compared with portions of said tube adjacent the ends of said tube.

24. A variable restrictor as claimed in claim 1 wherein said actuator includes a piezoelectric material and the actuator either contracts or allows expansion of said flattened section of said tube when a voltage is applied across said piezoelectric material, and maintains this altered state while said voltage is maintained across the material.

25. A refrigeration system including a variable restrictor between a high pressure energy shedding side and a low pressure energy absorption side, said variable restrictor being as claimed in claim 1.

26-27. (canceled)

28. A refrigeration system as claimed in claim 25 including a pump for moving refrigerant around a refrigeration circuit including said variable restrictor and a controller arranged to control the pumping capacity of said pump (for example by varying the speed and/or stroke of the pump) and arranged for controlling said actuator of said variable restrictor.

29. A refrigeration system as claimed in claim 28 wherein said controller receives input signals from at least one sensor connected with said refrigeration circuit, and from at least one sensor in a refrigeration location and coordinates pumping capacity of said compressor and actuation of said actuator of said variable restrictor in a response to signals received from said sensors.

30. A refrigeration system as claimed in claim 29 including air movement means (such as a fan) for generating a flow of air over a heat exchanger and the energy absorption side of said refrigeration system, said controller being arranged to control the capacity of said air flow generator.

31. A refrigeration appliance comprising an insulated enclosure, and a refrigeration system as claimed in claim 25.

32. A refrigeration system including a variable restrictor between a high pressure energy shedding side and a low pressure energy absorption side, said restrictor including:
a flow path having a movable flow control element movable through a first distance between an open position and a closed position,
an actuator including a drive member action on said flow control element having available travel between a first position and a second position that matches said first distance, said actuator including a piezoelectric material to move said drive member; and
a controller connected to apply a variable voltage across said piezoelectric material such that a first voltage level said movable flow control element is in an open position and at a second voltage level said movable flow element is in said closed position,
said open position corresponding to a flow resistance equivalent to between 1.5 m of 0.91 mm inside diameter capillary tube and 5.0 m of 0.66 mm inside diameter capillary tube.

33. A refrigeration system including a variable restrictor between a high pressure energy shedding side and a low pressure energy absorption side, said variable restrictor being as claimed in claim 32.

34. A refrigeration system as claimed in claim 33 including a pump for moving refrigerant around a refrigeration circuit including said variable restrictor and a controller arranged to control the pumping capacity of said pump (for example by varying the speed and/or stroke of the pump) and arranged for controlling said actuator of said variable restrictor.

35. A refrigeration system as claimed in claim 34 wherein said controller receives input signals from at least one sensor connected with said refrigeration circuit, and from at least one sensor in a refrigeration location and coordinates pumping capacity of said compressor and actuation of said actuator of said variable restrictor in a response to signals received from said sensors.

36. A refrigeration system as claimed in claim 35 including air movement means (such as a fan) for generating a flow of air over a heat exchanger and the energy absorption side of said refrigeration system, said controller being arranged to control the capacity of said air flow generator.

37. A refrigeration appliance comprising an insulated enclosure, and a refrigeration system as claimed in claim 36.
